(19) United States
(12) Patent Application Publication
(10) Pub. No.: US 2011/0276445 A1
(43) Pub. Date: Nov. 10, 2011

(54) Timekeeping Computer System with Image Capture and Quick View

(76) Inventor: Steven M. Chess, Fort Lauderdale, FL (US)

(21) Appl. No.: 13/185,772

(22) Filed: Jul. 19, 2011

Related U.S. Application Data
(63) Continuation-in-part of application No. 12/573,991, filed on Oct. 6, 2009.

(51) Int. Cl. G06Q 10/00; H04N 5/76

(52) U.S. Cl. 705/32; 348/231.99; 348/E05.031

(57) ABSTRACT

The method and system keeps track of employee time with a timekeeping computer and a camera. The camera captures an image of an employee upon clock-in by the employee. The computer maintains, in its memory, an earlier image of the employee. The employer enters an authenticate employee command, and the system visually displays the time-in image of the employee the clock in time and the earlier stored image of the employee. The system captures an exit image of the employee at clock-out. The employee's exit image and the time and date data is available for viewing.

This is a continuation in part of patent application Ser. No. 12/573991, filed Oct. 6, 2009, now pending, the contents of which is incorporated herein by reference thereto.

The present invention relates to a computer based method, computer readable medium containing programming instructions for the computer code implementing the method and a computer system for keeping track of employee time with employee image capture features and a quick view feature for the manager or employer.

### BACKGROUND OF THE INVENTION

Timekeeping programs are widely used wherein an employee logs in to a computer system indicating that he or she has begun his or her shift at the employer's location. After the employee finishes his or her work at the employer's location, the employee clocks out using the same computerized timekeeping program. However, there is no system wherein (a) an image of the employee at login is captured and (b) which permits the manager or employer to compare the clock in image (as well as the clock out image) with a pre-stored image of the employee.

U.S. Pat. No. 7,400,258 to Crespo discloses time clock and photo imaging system with a breathalyzer.

U.S. Pat. No. 7,333,718 to Yoshikawa discloses network, time & video capture system. This Yoshikawa patent disclosure states that the work data collection method includes photographing a series of different jobs done by a worker with a video camera, recording video signals of the jobs while recording time signals generated at predetermined fixed intervals and inputting a break point signal in the video at each break point between the jobs. The breakpoint facilitates the job image search and the date-time stamp authenticates the job image.

U.S. Pat. No. 3,780,378 discloses another time clock surveillance system. U.S. Patent Publication No. 2008/0004999 discloses a further networked time clock with a camera.

The following is a list of U.S. patent disclosures dealing with timekeeping systems: U.S. Pat. No. 7,466,223; U.S. Pat. No. 7,400,258; U.S. Pat. No. 7,333,718; U.S. Pat. No. 6,401,079; U.S. Pat. No. 4,063,251; U.S. Pat. No. 3,780,378; U.S. Pat. No. 3,531,794; U.S. Patent Publication No. 2008/0004999; U.S. Patent Publication No. 2006/0164090; U.S. Patent Publication No. 2003/0032447; U.S. Patent Publication No. 2002/0156670; WO 2007106945; JP 2003030706; JP 2002312551; JP 2002133056; and JP 56004986.

Other patent publications of interest are U.S. Patent Publication No. 2002/0175211 to Dominguez et al; U.S. Patent Publication No. 2005/0109836 to Ben-Assia and U.S. Patent Publication No. 2006/0087410 to Garcia et al.

### OBJECTS OF THE INVENTION

It is an object of the present invention to provide a timekeeping computer system and method which captures the employee's image at the time of clock in or initiation of the work shift, and permits the employee to clock out and captures a clock out image at that time and further permits the employer to compare the clock in image and the clock out image with a pre-stored or pre-existing employee image.

It is another object of the present invention to provide the manager with a quick view feature to authenticate the clock in image with the employee's application or pre-stored image. The application image is an earlier image of the employee.

It is a further object of the present invention to provide an image capture system with a data output such that the employer or manager can integrate the clock in and clock out data with a timekeeping program. Timekeeping programs, such as payroll account programs, are known.

It is an additional object of the present invention to reduce or eliminate employee fraud regarding clock in and clock out times with image capture functions.

It is an additional object of the present invention to have a timekeeping program including a “see me, hear me and photograph me” feature. This feature requires the user (a) to be greeted by the timekeeping system with an audible pronouncement or greeting (“hear me”), (b) to see himself or herself on the computer monitor or screen (the employee image captured by the timekeeper camera, and presented to the employee for confirmation, the “see me” feature) and (c) to select the “photograph me” key (the “enter” key on the keyboard) whereby the facial image of the employee is captured by the timekeeping camera and stored along with date and time information.

### SUMMARY OF THE INVENTION

The computer-based method, program and system keeps track of employee time with a computer located at an employer's location. The employer's location computer is linked to a camera or has an integral camera. The camera captures an image of an employee upon a time-in command The employee's image is stored with concurrent time and date data, preferable a time-date stamp on the image. This time-in time and date data is associated with the time-in employee image. The computer maintains, in its memory, an earlier image of the employee. Typically, but not necessarily, this is the employee's application image captured when the employee begins work with the employer (that is, on his or her first day at the job). The manager (or employer) enters an authenticate employee command, and the system and method then visually displays the time-in image of the employee and the earlier stored image of the employee and the concurrent time and date data (time-in data) associated with the time-in image. The system also uses a camera to capture an exit image of the employee when the employee clocks-out, that is, upon a time-out command. The employee's exit image and the then current time and date data (time-out time and date data) is stored in the computer's memory. The system compiles timekeeping records for the employee based upon the time-in data and the time-out time and date data. Further, timekeeping program includes a “see me, hear me and photograph me” feature at employee time-in, and again later at employee time-out. The employee is greeted by the timekeeping system with an audible pronouncement or greeting (“Hello, it is good to see you again today. Did you know that today is Beth's birthday?”) (“hear me”), is prompted to look at the camera (“Look here”), sees himself or herself on the computer monitor or screen (the “see me” feature) and then selects the “photograph me” key or time-in key (the “enter” key on the keyboard). The facial image of the employee is captured by the timekeeping camera and stored along with date and time information. Upon exit, a similar event is prompted and captured.

### BRIEF DESCRIPTION OF THE DRAWINGS

Further objects and advantages of the present invention can be found in the detailed description of the preferred embodiments when taken in conjunction with the accompanying drawings in which:

FIG. 1 is a flowchart or functional sequential diagram showing the time clock program and image capture and quick view program;

FIG. 2 diagrammatically illustrates the employer's location computer with a portion of the time clock program displayed thereon;

FIG. 3 diagrammatically illustrates the manager's report screen and shows, in a flow diagram and format, either pop up screens or overlay screens selectable by the manager permitting enlargement of images and permitting the employee's application image or earlier stored image to be shown next to or juxtaposed with respect to the timekeeping system clock in image of the employee;

FIG. 4 diagrammatically shows a different manager report screen with different functional aspects showing current clock in and clock out and stored images of employees;

FIG. 5 shows a further manager report screen utilizing a timekeeper program with an image and timekeeping database; and

FIG. 6 diagrammatically illustrates an interconnected computer system, interconnected with telecommunications networks, permitting communication between the employer's location computer and a plurality of additional computers and a remote timekeeping database.

### DETAILED DESCRIPTION OF THE PREFERRED EMBODIMENTS

The present invention relates to a computer based method, a computer program stored on computer program media, and a computer system for keeping track of employee time and with a image capture and quick view feature.

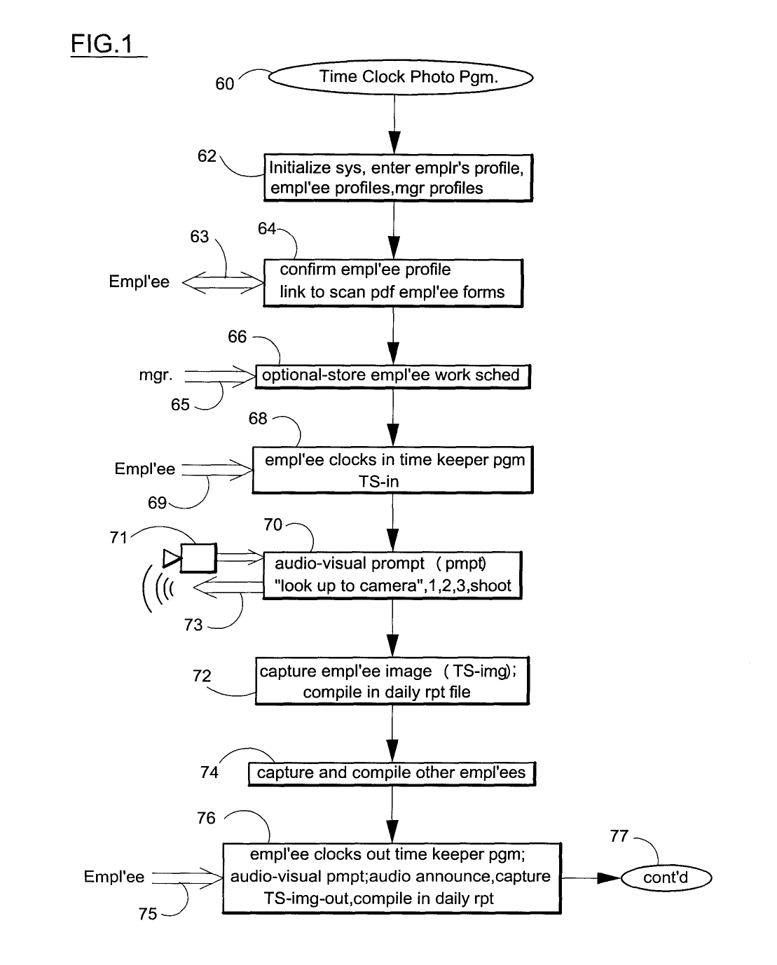

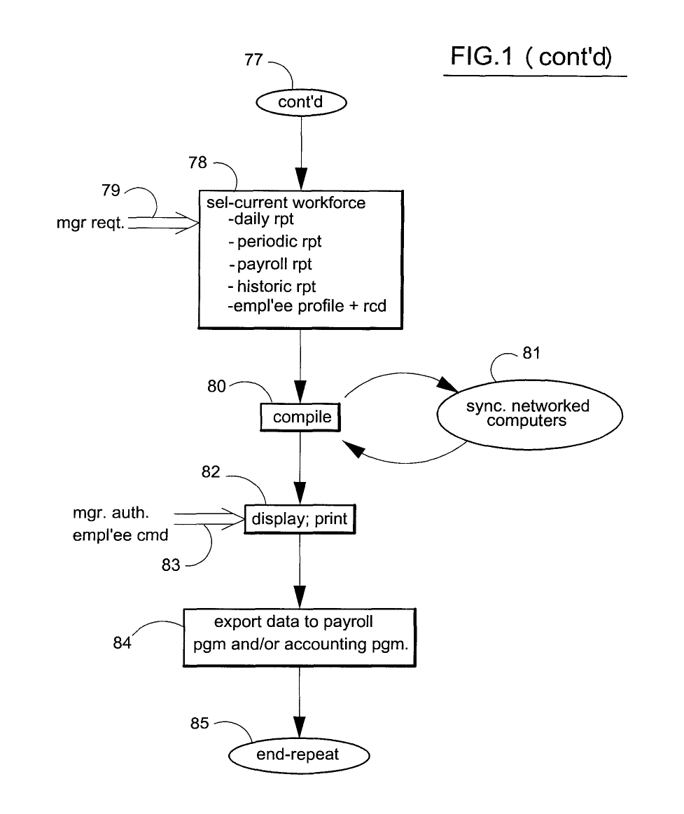

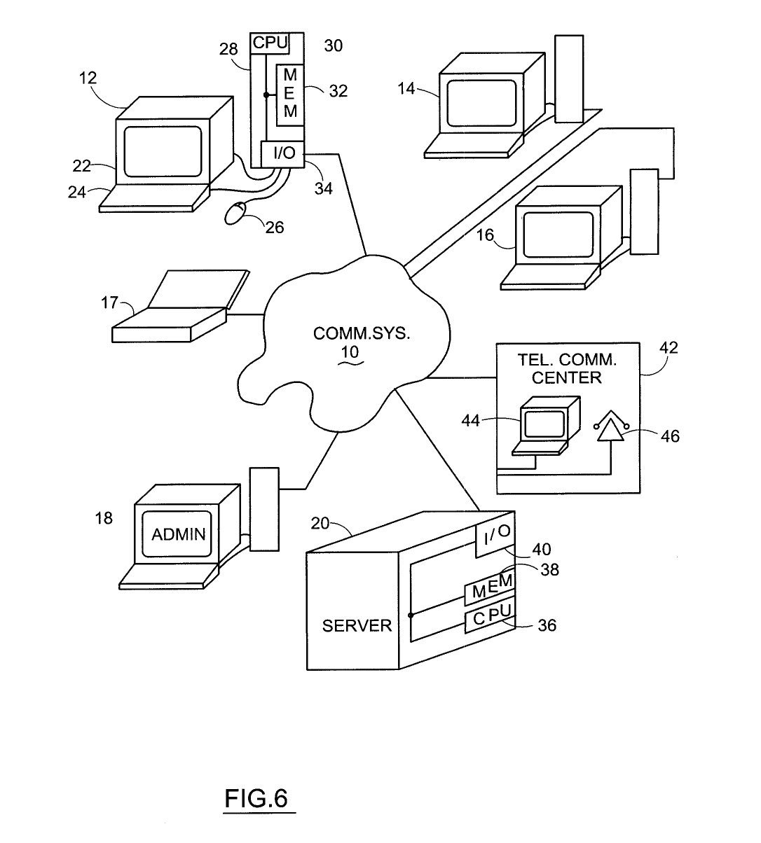

FIG. 1 provides a general flowchart and functional diagram for time clock photo program 60 in accordance with the principles of the present invention. Functional step 62 initializes the computer system which includes, in most instances, entering the employer profile (employer name, employer location address, phone, contact information, manager, emergency contact, and password for one or more managers or supervisors). Employee profiles are also entered into the system. The employee profiles include employee name, address, phone number, cell phone, potentially the social security number, and an image of the employee at the time he or she starts work or at a convenient time during the early employment cycle. The system also includes manager profiles in addition to employee profiles. Step or function 64 notes that employee has an input and output action such that function 64 confirms the data in the employee profile. The employee's earlier image is captured in the profile. This profile data is linked, in a preferred embodiment, to a scanned pdf file of the employee's completed application forms. Step or function 66, which is optional, stores the employee's work schedule. The manager, at input event 64, inputs the work schedule into the system. Alternatively, a work schedule may be generated from central computer 18 (FIG. 6) and downloaded into the employer's location computer 12 (discussed later in conjunction with FIG. 6). In other words, the system of the present invention can be implemented on a single employer computer or may be implemented over a computer network with a number of interconnected computers.

In function or step 68, the employee clocks in or inputs time into the timekeeper program. This is TS-in data (“TS” is time date stamp data). The employee's input 69 includes a clock in function. In step 70, the system provides an audio and potentially a visual prompt to the employee in order to capture the current image of the employee at the time of clock in TS-in. A camera or other image capture device 71 (maybe a video cam or camera with a short shoot time) supplies an input into function step 70. The audio output 73 is generated by a speaker providing the audio announcement. By providing audio and visual prompts to the employee, the employee will most likely look at the camera or capture system 71. The drawing shows audio prompt “look up to the camera, 1, 2, 3, shoot.” Other audio prompts may be utilized such as beeps, commands or horns. Further, the audio prompts can be changed daily to provide daily incentives for the employees or greetings to the employee in order to entertain the employee and start his or her day.

Functional step 72 captures the employee image as noted TS-img-in data. This image is compiled in a daily report file for the employer. Functional step 74 captures and compiles other data for other employees. This data includes clock in data TS-in, as well as image data TS-img-in. Function 76 notes that the employee has clocked out at TS-out per the timekeeper program. The employee's “exit command” or clock out command input 75 is noted in function 76. An visual prompt may be utilized as well as an audio announcement and the image is captured as a clock out image TS-img-out. The TS-out data and image is compiled in the daily report.

Therefore, when the employee clocks into the timekeeping system at function 68, the employee activates a time in command 69 to clock in the timekeeping program. This time in command then creates the audio-visual prompt for the employee to look at camera 71 while the camera obtains the employee's then current image and concurrent time and date data. The time and date data is “concurrent” or substantially simultaneous with the capture of the image. The same action occurs when an employee clocks out. The exit image of the employee is created by the time out command 75 with respect to function 76. An exit employee image TS-img-out is captured and the time out data and date data is created as TS-out. FIG. 1 continues by jump point 77.

To enhance the operation of the system and the method, the timekeeping program includes a “see me, hear me and photograph me” feature. This feature includes the following processing steps, controlling the computer hardware, camera and monitor. (1) The employee approaches the timekeeping system and selects either a pre-defined key or, if the system is dormant, simply strikes any key on the keyboard of the computer. (2) The system wakes up and audibly presents a greeting to the employee via a speaker coupled to the computer. The greeting may include a inspirational message (Good Morning, It is nice to see you again. ABC business is pleased to see you back with the team”) or, alternatively a customized message for that day or week (the greeting plus “Remember, it is Beth's birthday today” or “Today is Einstein's birthday. Invent something new”). As an additional enhancement, the timekeeping system may announce a greeting message fed to the system via the Internet on a daily or otherwise periodic basis which live-feed message is either unique to the ABC business or is of inspirational value unique to the present day. In this manner, the timekeeping system always presents a new greeting and this new live-feed greeting message stimulates the employee to perform at a higher level than normal, that is, at a higher level than if a repetitive message was continually played and announced to the employee.

(3) The system announces to the employee “look at the camera.” (4) The system then captures the employee's image by activating the camera. As an additional feature after image capture, the employee's image could be matched with a pre-loaded employee's image and both the current day-time stamped image and the previously stored image can be displayed to the employee. With this current and stored image display, presented to the employee, this feature significantly reduces the probability that a false “clock-in” is made by the current employee. If employees know that both images are shown to them at each clock-in and clock-out, there is a smaller probability that fraud will occur at clock-in (one employee timing in for another employee) or at clock-out at time-exit. If a networked system is used, with a local computer at the local employer's business, and the server or central stations computer at a remote location, the new image and stored image presentation can be made to a remotely located supervisor at the central station. (5) The system then acknowledges the clean photo capture of the employee at check-in or time-in. The image is stored with the time and date stamp in the database. (6) Further enhancements may include the inputting by the employee of his or her employee number or code, or a swipe id card, all in combination with the timekeeping program discussed herein. (7) At time-out or when the employee is to leave work, the system repeats steps 1-6 as discussed above, with or without the optional aspects.

Some of the key features are the (a) greeting by the timekeeping system with an audible pronouncement or greeting (“hear me”), (b) announcing to the employee to look at the camera, (c) capturing the image by the employee striking a “photograph me” key or having the system count down and announce “look at the camera, 1, 2, 3 and ‘activate the camera to capture the employee's image’” (“see me” feature), (d) displaying the employee's image on the computer monitor or screen (the employee image captured by the timekeeper camera, and presented to the employee for confirmation, the “see me 2^{nd} time” feature) and (e) storing the facial image of the employee along with date and time information.

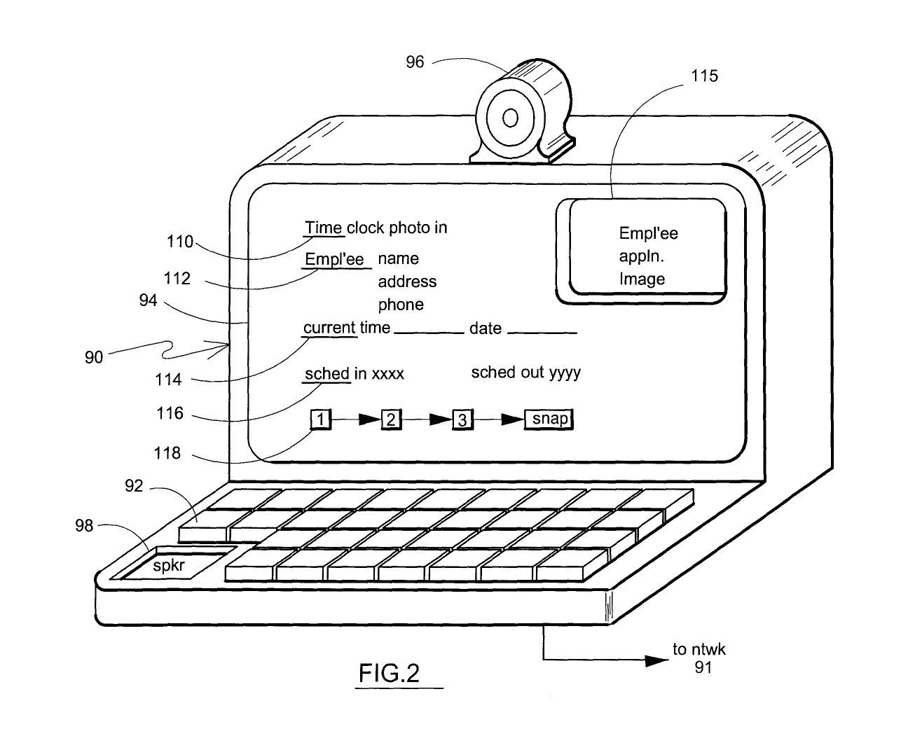

Report selection step 78 enables the manager to request at command 79 one or more reports including the current workforce (the employees who are currently on site at the employer's location), a daily report for all workers who have worked during that day over a daily employment accounting cycle, a periodic report (such as a shift report), a payroll report for different employment accounting cycles, a historic report, as well as an employee profile and record. Function 80 compiles the information at the manager's request. This may include synchronization of the local employer's computer memory with remotely network computers. This synchronization of network computers is noted by function 81. Function 82 displays the report to the manager and permits printing of the reports. The manager “authenticate employee” command 83 is applied in function 82. This act enables the manager to authenticate that the employee who clocked in is the same employee in the employer's records from the earlier stored records. This authentication step and quick image display of an earlier stored image of the employee is discussed later in connection with FIGS. 2-4.

Function 84 exports the data to a payroll program or other accounting program. Function 85 either ends the program or repeats the process for another employee.

FIG. 2 diagrammatically illustrates a computer at the employer's location with the timekeeping program with an image capture and quick view. Computer 90 includes keyboard 92 with a plurality of keys permitting a user to input data and a display system or monitor 94. Camera 96 is either mounted atop computer 90 or is integral with computer 90. Computer 90 may include a swipe card slot if the employees carry security badges or cards. Short frame shooting video cameras (cam-corders) may also be used as cameras. In any event, digital camera 96 is electronically linked to the computer's CPU and its memory store system. Computer 90 also includes speaker 98 which issues audio announcements to the user.

Program 110 is the “time clock photo in” program and is the input screen for the program. Region 112 is the employee's profile data or part of the profile data including at least the employee name. The employee's address and phone is optional. Current time display 114 shows both the day and time of day and the date. Region 116 shows the time that the employee is scheduled to appear and begin work at the employer's location, that is, at schedule time xx. The scheduled out or departure time yy is also shown. The display sequence 118 visually displays to the user, now an employee, that after displaying “1, 2, 3” in highlighted sequence, upon visualization of “snap,” camera 96 captures the image of the employee. This capture is the time-in image. In display region 115, the employee's application image or earlier stored image is shown. Since the time-in image is captured by computer 90, the employer or manager can easily check the earlier stored employee application image 115 with the concurrently acquired time-in image. Computer 90 is coupled to network 91. See FIG. 6. The manager may be at a remote computer.

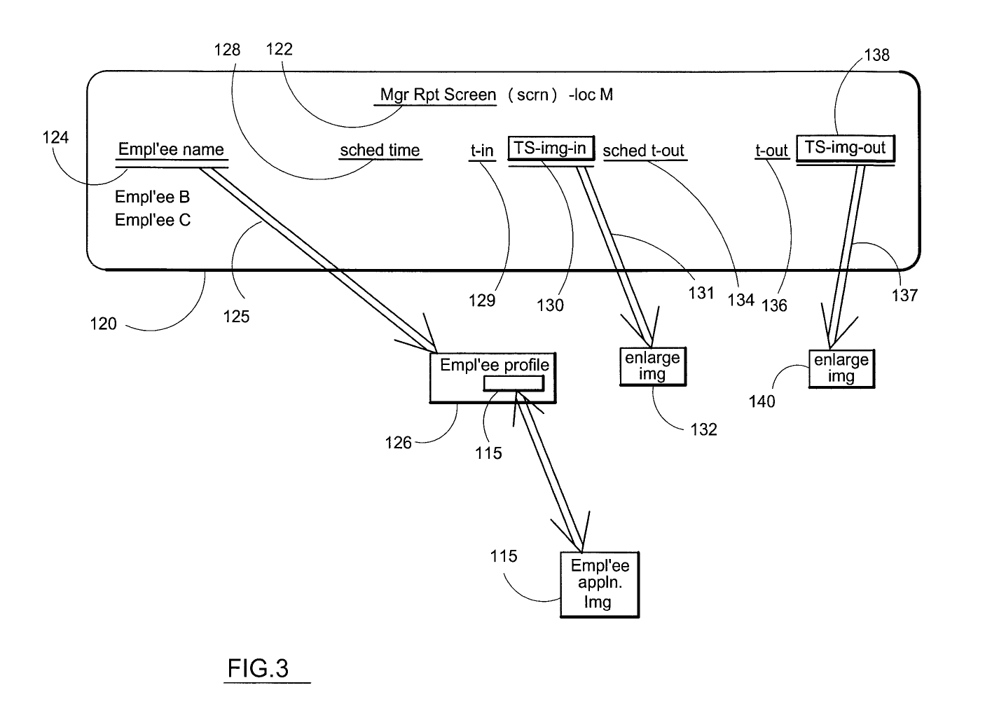

FIG. 3 diagrammatically shows one embodiment of an employer or manager report screen 112. The manager report screen is for employer location M. As is known, some employers have many locations. The term “employer's location” refers to the current location where the employee is working and is subject to the timekeeping program and system of the present invention. With respect to display screen 120, this display screen may be provided on display monitor 94 of computer 90 in FIG. 2. Alternatively, the manager report screen display 120 could be displayed on remote computers shown in connection with FIG. 6. The central administrative computer server may operate the program as an ASP or web-based program with a network computer 90 at the job site.

Employee region 124 shows employee's name. In one embodiment, employee name display region 124 is a “hot button” selectable display such that the manager or user may select employee name, and the system then jumps with authenticate or “check employee” command 125 to the employee profile 126. Employee profile 126 includes, as part of the display function, the earlier captured employee application image 115 which is displayed by the authentication function. The user or manager may close out of employee profile 126 and return to manager report screen 120. In this manner, a manager can quickly view the original or earlier stored employee image, preferably image of the employee when he or she applied for the position, with the clock in or clock out image. The application image is next to the clock in image to confirm the employee's identity at clock in.

Progressing from left to right, display screen 120 includes the schedule time in day and time 128, the clock in or posted time TS-in 129, and the clock in image TS-img-in. As noted in function 131, if the user sets the hot button display area TS-img-in, the computer system enlarges the image as shown by enlarged image function 132. In this manner, the manager can look at the clock in image TS-img-in at a certain time and select the employee's application image 115 relating to visually ascertain that the employee is the same employee who clocked in as the employee in the employee's records. This quick view of the clock in employee image and the earlier stored employee application image is one the several important features of the present invention. The schedule time out 134 is shown in manager report screen display 120. The actual clock out time TS-out 136 is also shown. The clock out image TS-img-out is shown. This image can be enlarged by activating command 137 by clicking on the hot area of the screen and the enlarge image display function 140 is noted in FIG. 3. The clock in image TS-img-in and clock out image TS-img-out are miniature thumb nail images.

Similar numerals designate similar items throughout the drawings.

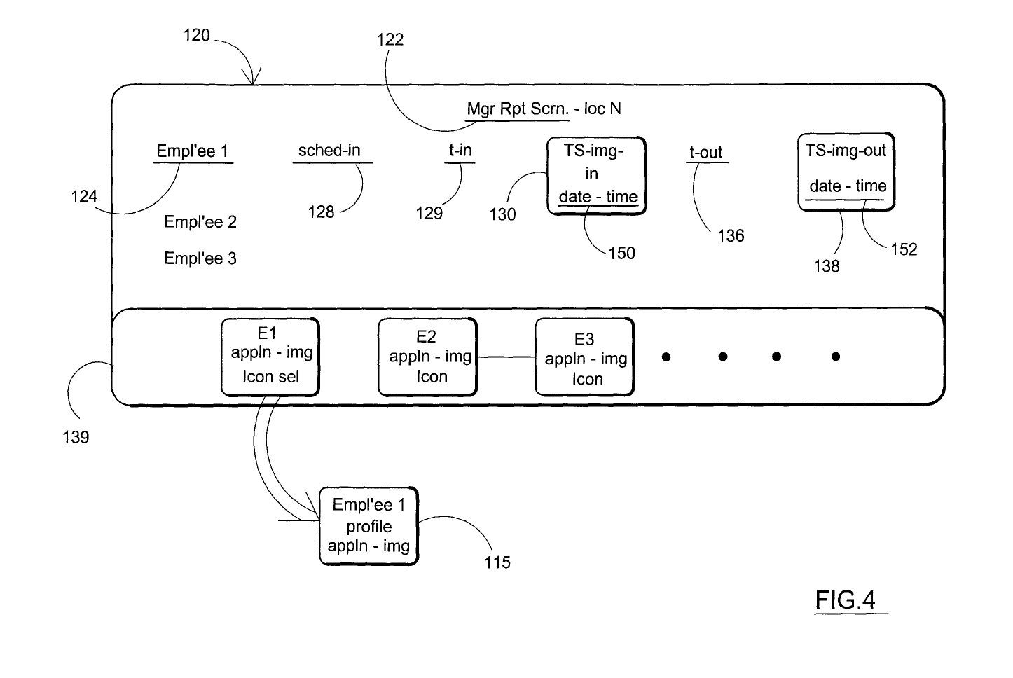

In FIG. 4, a different version of manager report screen 122 is provided, this time at employer location N. Display 120 includes employee data 124, schedule in time 128, clock in time 129, clock out time 136. The clock in image TS-img-in has a date-time stamp embedded in the image, that is a time and date stamp that the image was taken. Time and date stamp 150 is noted in connection with the clock in image 130. The same is true regarding clock out image TS-img-out. Time and date stamp 152 is embedded in image 138. In the lower portion 139 of display screen 120, the user-manager sees small icons for employee E1, E2 and E3. These icons permit the manager to select the application image for that employee E1, E2, E3, by selecting the icon. The manager causes the computer system to generate a pop up or other small display of the employee E1 profile and, more importantly, the employee E1 application image 115. The images are hot button selectable display areas. In this sense, the manager selection of E1 icon selection is a “verify employee” command. Upon selection of the verify employee command, the earlier stored image or application image of the employee 115 is displayed on screen 120. Since the clock in image 130 and clock out image 128 is also displayed, this permits the manager to visually confirm that the same employee who clocked in and clocked out is the same employee that is the subject to the application image. In this sense, the “authenticate employee” command is one of several functions which enables the manager to see the employee application image juxtaposed or next to the clock in image or clock out image. If the manager wants additional data, he or she may select a “display current employment condition” command which would, in one embodiment, show the entire employee profile 126 as noted in FIG. 3. A hot button selectable display may activate the command. If the employee is currently working at the employer's location, the “display current employment condition” command results in displaying the clock in image of the employee and the associated clock in time and date data.

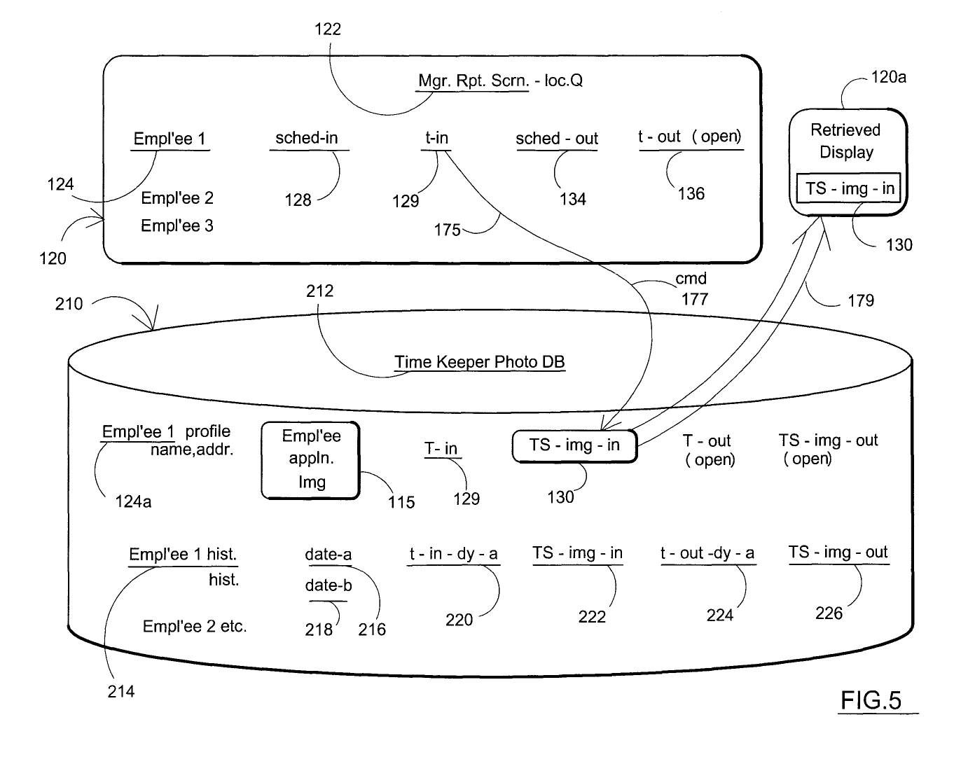

FIG. 5 diagrammatically illustrates another embodiment of the manager's display showing several display screens 120 and 120a (screen 120a being displayed subsequent screen 120) as well as a timekeeper database 210. The manager report screen 122 includes display 120 and shows employees at employer location Q. Employee data 124 is shown for employee 1, employee 2, and employee 3. The schedule in time and date data 128 and schedule out data 134 is illustrated. The clock in time 129 is a hot button display region such that, upon actuation by the manager, the system issues an authenticate employee command 177. The system then activates flow process 175 to retrieve the clock in image TS-img-in 130 from the database. Upon retrieval of the clock in image 130, display screen 120 converts to display screen 120a, called in FIG. 5 a “Retrieved display,” and the clock in image 130 is shown. The database may be any segmented file with cells for time in, time out and images linked thereto.

In this embodiment, database 210 is a timekeeper photo database 212. This database keeps a considerable amount of information including employee 1 data 124a and the employee profile. Employee 1 historic data 124 shows the history at date-A 216 and the history for the employee at date-B 218. The data for employee 1 includes the employee application image 125, and clock in time 129. Since the employee has not yet clocked out, the clock out data 136 is open or not available. The timekeeper database 212 uses an “open” label for the T-out or data clock out time and the clock out image TS-img-out. With respect with employee history 214, for date-A, there is stored data for clock in time and date data 220, a clock in image 222 and a time and date clock out image 226 for day-A 224. In this manner, the employee's stored image is maintained in a database either on the employer's location computer or at a central location discussed later in conjunction with FIG. 6. In any event, the data from an employer's location computer can be uploaded to a central computer after a predetermined period of time such as ten minutes after each employee logs in or may be uploaded to the central computer at a predetermined time during an employment accounting cycle. For example, the system may upload to central computer data at 11:42 PM (a predetermined time) each day (the employment account cycle).

It should be noted that the present invention can be configured as an application service provider or ASP program. In this manner, the employer's location computer primarily downloads input and output screens and uploads data to the central computer which stores data. The central computer downloads information via web browser screens to the local computer or the employer's location computer. The local computer at the employer's location is prompted to visually and audibly announce to the employee to “look at” the camera and then the system captures the employee's image by entering the camera. Clock in and Clock out data is treated similarly. The data is then temporarily stored in the local computer and then uploaded to the central computer. Further, the present invention can be implemented using a database on one computer and used by a group of networked computers and the networked computers operate at various employer locations.

### General System Description

The present invention relates to a timekeeping and image capture method and a system. Throughout the description of the present method and system, abbreviations are sometimes utilized describing certain features. The following Abbreviations Table lists these items.

### Abbreviations Table

admin administrator
ASP application service provider—server on a network
API application program interface
appln.img. application image
authen authenticate, such as authenticate employee
bd board
CD-RW compact disk drive with read/write feature for CD disk
comm. communications, typically telecommunications
CPU central processing unit
cmd command
db data base
disp display or code
doc document
dr drive, e.g., computer hard drive
descrpt description
dy day
equip equipment
empl'r employer
empl'ee employee
freq frequency
fnc function, as in system function
geo geographic location or code
gen general
hist historic as in historic session records
I/O input/output
IP Internet Protocol such as IP address
incr increase or increment
loc location
mem memory
mess message as in SMS or text message
mgr manager
mth month
ntwk network
obj object, for example, a data object
pgm program
P/W password
pg web page
pix picture, usually digital picture or image
pmt payment
pmpt prompt, as in prompt a user to input data
Q quantity
rcd database record or record profile
re regarding or relating to
reg'd registered as in reg'd user or employee
rel relevancy or relevant
reqt request
rev review
rpt report
sch. search
sched schedule
scrn screen
sel select or selector
spkr speaker
sys system
sys oper system operator
sess. session
t time
tele-com telecommunications system or network
TS time, date stamp
txt text
URL Uniform Resource Locator, x pointer, or other network locator
vid video
wk week

FIG. 6 diagrammatically illustrates the global telecommunications system or Internet 10 which enables communication and data transport between a plurality of relatively independent computer systems 12, 14, 16, 17, 18 and 20. Computer system 12, which may be the employer's location computer (see FIG. 2), includes monitor 22, input device or keypad 24, input device or mouse 26, and processor unit 28. Processor unit 28 includes a central processing unit or CPU 30, memory 32 and an input/output or I/O device 34. It should be appreciated that memory 32 represents many types of data storage including hard drives, volatile and non-volatile memory, and removable drives. Also, I/O 34 represents a plurality of input/output devices which are utilized to couple items which are peripheral to processing unit 28. I/O 34 is connected to Internet 10. Computer 17 is a laptop computer which can easily be disconnected from Internet 10. If the timekeeping program, with image capture, is used in connection with transient jobs or work sites, the timekeeping program may be on laptop 17 wherein the laptop is fitted with a camera. Computer 18 is an administrative computer which assists in the overall control and operation of the system and the method described herein. If there are several employer locations (see FIGS. 3, 4 and 5 and locations M, N and Q), the time and image data may be uploaded to central computer 18 from various remote computers 12, 17. In a distributed system, computers 12, 14, 16 and 17 are client computer systems operated by managers at different employer locations, interconnected together with the central computer 18 via the Internet telecom network.

In one embodiment when the timekeeping program is an Application Service Provider, or ASP, the system and method are deployed on Internet 10 via computer system server 20. Server 20 includes CPU 36, memory 38 and I/O 40, and is coupled to Internet 10.

In another embodiment of the present invention, the system or processing system or method may be supplemented by telephone communications center 42. The telephone communications center typically includes one or a plurality of computers 44 and one or more telephones 46. Human operators may answer telephone inquiries from a managers or employees, and may send telecom alerts to email or cell phones if a time-in employee image does not match an employee application image (a pre-stored earlier image). The input of information can be facilitated by a person at telephone communication center 42. For example, computer 44 could display questions which the operator could audibly present via telephone 46 to a caller. The operator would input into computer 44 the caller's answers and system 44 could generate appropriate responses to complete data entry forms for the system.

In a preferred embodiment, time-in data and time-in images are obtained by utilizing an employer's location computer 12 (a client computer). Data ultimately is compiled by central server 20. The information obtained by computer 12 is ultimately stored in server 20.

Although the system and method is described generally for use in conjunction with Internet 10, the system and method could be utilized exclusively by a single computer, such as laptop computer 17, operated by a meeting planner or a hotel representative. Laptop 17 could be utilized with a CD-ROM storing a major portion of the data bases necessary to carry out the principles of the present invention. Data uploads to central computer are periodic (daily or monthly) or random after the employee clocks in or clocks out. Further, the computer processing system could be deployed over a local area network or a wide area network or utilized exclusively in-house by a single company.

### Discussion of Hardware and Software Implementation Options

The present invention could be produced in hardware or software, or in a combination of hardware and software, and these implementations would be known to one of ordinary skill in the art. The system, or method, according to the inventive principles as disclosed in connection with the preferred embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as a local area network (LAN) or widely distributed network (WAN) over a telecommunications system (such as the Internet) as would be known to a person of ordinary skill in the art.

According to the inventive principles as disclosed in connection with the preferred embodiments, the invention and the inventive principles are not limited to any particular kind of computer system but may be used with any general purpose computer, as would be known to a person of ordinary skill in the art, arranged to perform the functions described and the method steps described herein. The operations of such a computer, as described above, may be according to a computer program contained on a medium for use in the operation or control of the computer, as would be known to person of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM or other optical memory storage devices, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

The claims appended hereto are meant to cover modifications and changes within the spirit and scope of the present invention.

What is claimed is:

1. A computer-based method for keeping track of employee time with a computer located at an employer's location comprising:
providing a computer at the employer's location, said computer linked to a camera adapted to capture an image of an employee upon a time-in command and a memory store for storing images and timekeeping data;
prompting the employee to look at the camera by presentation of audio announcement greeting;
capturing an image of said employee with said camera when said employee enters said time-in command and in response to the audio announcement greeting;
displaying a previously stored image of said employee in response to the audio announcement greeting and the capture of the employee's image;
storing the employee's captured image as he or she looks at the camera with the storage of concurrent time-in time and date data;
maintaining in said memory store an earlier image of said employee when said employee looks at another or the same camera at an earlier time;
at a later time, prompting the employee to look at the camera by presentation of an exit audio announcement greeting;
capturing an image of said employee with said camera as he or she looks at the camera when said employee enters a time-out command and storing the then captured image as an exit employee image with concurrent time and date data as time-out time and date data all while displaying said previously stored image of said employee in response to the audio exit announcement;
upon an authenticate employee command, visually displaying the time-in image of said employee, the exit employee image, both when the employee looks at the camera, and the previously stored image of said employee, when said employee is looking at said camera, and the concurrent time and date data associated with the time-in image;
compiling timekeeping records for the employee based upon the time-in data and the time-out data.

2. A computer-based method for keeping track of employee time as claimed in claim 1 wherein the computer located at the employer's location is communicatively connected to a network of remote computers, the method further comprising:
at least one remote computer accessing said memory store in the employer's location computer and data processing said employee's image and concurrent time and date data by at least one data process from the group of data processes including:
copying said employee's image and concurrent time and date data into a database;
displaying said employee's image and concurrent time and date data with said previously stored image of said employee;
displaying said employee's image and concurrent time and date data with another earlier stored image of said employee in a database;
copying said employee's image and concurrent time and date data into a database and then deleting said employee's image and concurrent time and date data from the employer's location computer after a predetermined period of time; and,
copying said employee's image and concurrent time and date data into a database and then deleting said employee's image and concurrent time and date data from the employer's location computer at a predetermined time during an employment accounting cycle.

3. A computer-based method for keeping track of employee time as claimed in claim 1 including simultaneously displaying the time-in image of said employee and the previously stored image of said employee and the concurrent time and date data associated with the time-in image.

4. A computer-based method for keeping track of employee time as claimed in claim 1 wherein the authenticate employee command includes a display current employment condition command and a verify employee command;
upon said display current employment condition command, displaying the time-in image of said employee and the concurrent time-in time and date data; and
upon said verify employee command, displaying said previously stored image of said employee juxtaposed near said time-in image.

5. A computer-based method for keeping track of employee time as claimed in claim 1 wherein the computer located at the employer's location is communicatively connected to a network of remote computers, the method further comprising:
at least one remote computer having stored therein said earlier employee image;
the method including:
said employer location computer communicating over said network to said at least one remote computer and downloading said previously stored employee image either upon said authenticate employee command or earlier upon a synchronize employee data command.

6. A computer-based method for keeping track of employee time as claimed in claim 5 wherein said at least remote computer maintains a database with a plurality of previously stored employee images for a plurality of employees, and a compilation of time-in image of said employee and the concurrent time-in time and date data for respective employees.

7. A computer-based method for keeping track of employee time as claimed in claim 1 wherein the concurrent time and date data associated with the time-in image is time-in time and date data.

8. A computer readable medium having non-transitory programming instructions stored thereon for keeping track of employee time adapted for use with a computer located at an employer's location, the employer's location computer having a camera adapted to capture an image of an employee upon a time-in command and a memory for storing images and timekeeping data, the programming instructions comprising:
providing a computer at the employer's location, said computer linked to a camera adapted to capture an image of an employee upon a time-in command and a memory store for storing images and timekeeping data;
prompting the employee to look at the camera by presentation of audio announcement greeting;
capturing an image of said employee with said camera when said employee enters said time-in command and in response to the audio announcement greeting;
displaying a previously stored image of said employee in response to the audio announcement greeting and the capture of the employee's image;
storing the employee's captured image as he or she looks at the camera with the storage of concurrent time-in time and date data;
maintaining in said memory store an earlier image of said employee when said employee looks at another or the same camera at an earlier time;
at a later time, prompting the employee to look at the camera by presentation of an exit audio announcement greeting;
capturing an image of said employee with said camera as he or she looks at the camera when said employee enters a time-out command and storing the then captured image as an exit employee image with concurrent time and date data as time-out time and date data all while displaying said previously stored image of said employee in response to the audio exit announcement;
upon an authenticate employee command, visually displaying the time-in image of said employee, the exit employee image, both when the employee looks at the camera, and the previously stored image of said employee, when said employee is looking at said camera, and the concurrent time and date data associated with the time-in image;
compiling timekeeping records for the employee based upon the time-in data and the time-out data.

9. A computer system for keeping track of employee time comprising:
a computer located at an employer's location with a display and a speaker;
a camera linked to or incorporated with the employer's location computer, the camera adapted to capture an image of an employee upon a time-in command;
the employer's location computer having a memory for storing images and timekeeping data, said memory store maintaining in storage an earlier image of said employee when said employee has looked at another or the same camera at an earlier time;
means for prompting the employee to look at the camera by presentation of audio announcement greeting via said speaker;
means for capturing an image of said employee with said camera when said employee enters said time-in command and in response to the audio announcement greeting;
means for displaying a previously stored image of said employee on said display in response to the audio announcement greeting and the capture of the employee's image;
means for storing the employee's captured image in said memory as he or she looks at the camera and storing the concurrent time-in time and date data in said memory;
upon an employee command at a later time, means for prompting the employee to look at the camera by presentation of an exit audio announcement greeting via said speaker;
means for capturing an image of said employee with said camera as he or she looks at the camera when said employee enters a time-out command and storing the then captured image as an exit employee image with concurrent time and date data as time-out time and date data in said memory;
means for displaying said previously stored image of said employee in response to the audio exit announcement;
upon an authenticate employee command, means for visually displaying the time-in image of said employee, the exit employee image, and the previously stored image of said employee, and the concurrent time and date data associated with the time-in image;
means for compiling timekeeping records in said memory for the employee based upon the time-in data and the time-out data.

10. A computer system for keeping track of employee time as claimed in claim 9 wherein the concurrent time and date data associated with the time-in image is time-in time and date data;
the computer system including:
means to capture an exit image of the employee upon a time-out command with said camera and to store the same as an exit employee image with concurrent time and date data as time-out time and date data in memory in the employer's location computer;
means for compiling timekeeping records for the employee based upon the time-in data and the time-out time and date data.
